(19) United States
(12) Patent Application Publication
(10) Pub. No.: US 2019/0228379 A1
(43) Pub. Date: Jul. 25, 2019

(54) Attendance Consistency Management System and Attendance Consistency Management Method

(71) Applicant: Hitachi Solutions, Ltd., Shinagawa-ku, Tokyo (JP)

(72) Inventors: Satomi SHIMADA, Tokyo (JP); Kenichirou OKAYAMA, Tokyo (JP); Ryou TAMAGAKI, Tokyo (JP)

(21) Appl. No.: 16/337,663

(22) PCT Filed: Dec. 20, 2017
(86) PCT No.: PCT/JP2017/045661

§ 371 Date: Mar. 28, 2019

(30) Foreign Application Priority Data
Mar. 29, 2017 (JP) 2017-064478

(51) Int. Cl. G06Q 10/10

(52) U.S. Cl. CPC G06Q 10/1091

(57) ABSTRACT

An attendance consistency management system for managing consistency with attendance information includes: a beacon detection result collecting unit that is distributedly installed along an entrance path into and exit path from the inside of a building or an office, collects beacon ID information from a plurality of receiving terminals detecting a beacon of a transmission terminal carried by an employee, and records the beacon ID information together with detection time information; and an attendance matching processing unit that calculates the earliest detection time, the latest detection time, and remaining time after regular time of the employee, based on the sequential data table of detection time for each beacon ID and regular time information of an employee specified by the beacon ID, and determines consistency with attendance information entered by the employee on self-reporting, working regulations of individual employees, and working regulations of a company.

### TECHNICAL FIELD

The present invention relates to an attendance consistency management system and an attendance consistency management method.

### BACKGROUND ART

In basic attendance management which is one function of a personnel management system, it is performed to manage daily working hours and overtime hours, monthly working hours and overtime hours, and the like, by mainly managing attendance time and quitting time. Also, the number of working day or holidays such as regular attendance, paid or substitute holidays, and special holidays is also managed.

There are two patterns of a time recorder and self-reporting as an attendance management recording method.

In an attendance management method of a self-reporting system, there are advantages that employees self-manage daily working hours to work efficiently and it does not take time and effort to compile working hours by a time recorder. However, in accordance with the notification of “Standards on measures to be taken by employers in order to properly check working hours” by the Ministry of Health, Labor and Welfare, companies need to take measures.

In attendance management using the time recorder, in recent years, various types of engraving methods such as a method of performing engraving by entering an ID and a password, a method of performing engraving by using fingerprint authentication, a method of performing engraving by using an IC card can be selected according to work situations.

Patent Document 1 discloses a technique that allows a worker to carry out a reading medium such as a wireless IC tag in order to specify actual working hours of the worker in a manufacturing process, and calculates working hours as a period of time from time when the worker is firstly detected to time when the worker is lastly detected within a detection area of the manufacturing process, by performing reading processing at predetermined intervals by means of a person detection apparatus installed on the periphery of the detection area of the manufacturing process.

### CITATION LIST

### Patent Document

Patent Document 1: JP 2007-4619 A

### SUMMARY OF THE INVENTION

### Problems to be Solved by the Invention

Relating to strictly managing attendance management as stated in the notification of the Ministry of Health, Labor and Welfare, objective evidence for starting time and closing time of the work of an employee by attendance management is required in an audit by Labor Standards Bureau and the like.

The management of attendance time and quitting time using the log-on and log-off of a PC as a trigger has been mainly used for the engraving method of the related art in an attendance management system for an office. In this method, there is a possibility that the employee is working in the office even after shutting down the PC, so that evidence that registered information is correct cannot be obtained in the attendance management system of the related art.

Also, although it is possible to strictly check attendance time and quitting time by installing entrance and exit gates, it is necessary to install large scale and expensive hardware in the building entrance portion, which may be a burden both in terms of cost and space.

An object of the present invention is to propose a system capable of simply providing objective evidence by technology in which there is free from a burden in terms of cost and space for introducing hardware, and it is possible to obtain attendance time and quitting time without going through actions of an employee to prevent the employee from arbitrarily manipulating her/his attendance time and quitting time, while allowing the employee to be hardly aware of what happens.

### Solutions to Problems

According to a preferred example of the present invention, in order to solve the above-mentioned problems, there is provided an attendance consistency management system, including: a beacon detection result collecting unit that is distributedly installed along an entrance path into and exit path from the inside of a building or an office, collects beacon ID information from a plurality of receiving terminals detecting a beacon of a transmission terminal carried by an employee, and records the beacon ID information together with detection time information; a detection result calculating unit that generates a sequential data table of detection time for each beacon ID based on the recorded beacon ID information and detection time information; and an attendance matching processing unit that calculates the earliest detection time, the latest detection time, and remaining time after regular time of the employee, based on the sequential data table of the detection time for each beacon ID and regular time information of an employee specified by the beacon ID, and determines consistency with attendance information entered by the employee on self-reporting, working regulations of individual employees, and working regulations of a company.

As another feature of the present invention, the attendance consistency management system further includes a notification processing unit, in which, in a case where an item with inconsistency to be determined is present as a determination result of the attendance matching processing unit, a notification processing unit generates a report for submitting a result with inconsistency to be determined, and transmits the generated report to an employee terminal or a manager terminal.

As still another feature of the present invention, in the attendance consistency management system, a single gateway device intervenes on a path through which the beacon detection result collecting unit collects beacon ID information from the plurality of receiving terminals, and the gateway device transmits, to the beacon detection result collecting unit, information obtained by adding detection time information when receiving the beacon ID information detected from each receiving terminal.

Also, the attendance consistency management method is preferably a method of collecting information on attendance time and quitting time of an employee and determining consistency with attendance information, when executed by a computer, the method including: a step of collecting beacon ID information from a plurality of receiving terminals detecting a beacon of a transmission terminal carried by an employee, and recording the beacon ID information together with detection time information, through distributed installation along an entrance path into and exit path from the inside of a building or an office; a step of generating a sequential data table of detection time for each beacon ID based on the recorded beacon ID information and detection time information; a step of calculating the earliest detection time, the latest detection time, and remaining time after regular time of the employee based on the sequential data table of detection time for each beacon ID and regular time information of an employee specified by the beacon ID, and determining consistency with attendance information entered by the employee on self-reporting, working regulations of individual employees, and working regulations of a company; a step of generating a report for submitting a result with inconsistency to be determined, in a case where there is present an item with inconsistency to be determined in the step of determining consistency, and transmitting the generated report to an employee terminal or a manager terminal.

### Effects of the Invention

In a case where an employee carries a beacon terminal, it is possible to obtain attendance time and quitting time while allowing the employee to be hardly aware of what happens.

Also, since the employee does not need to perform an engraving operation for attendance management, it is possible to obtain objective evidence by preventing the employee from arbitrarily manipulate attendance time and quitting time.

### BRIEF DESCRIPTION OF THE DRAWINGS

FIG. 1 is a system configuration diagram of an attendance consistency management system proposed in an embodiment.

FIG. 2 is a configuration diagram of an attendance consistency management system apparatus.

FIG. 3 is a block diagram of a BLE receiving terminal, a beacon terminal, and a gateway device.

FIG. 4 is an overall flowchart of an attendance consistency management system apparatus.

FIG. 5 is a flowchart of detecting one beacon ID and executing detection result processing.

FIG. 6 is a flowchart of matching and notification processing.

FIG. 7 is a diagram illustrating a data table format in a beacon DB.

FIG. 8 is a diagram illustrating a data table format in a receiving terminal DB.

FIG. 9 is a diagram illustrating a data table format in an individual beacon detection result DB.

FIG. 10 is a diagram illustrating a data table format in an individual employee time management DB.

FIG. 11 is a diagram illustrating a data table format in a personal policy DB.

FIG. 12 is a diagram illustrating a data table format in a company policy DB.

FIG. 13 is a diagram illustrating a data table format in an individual employee attendance input DB.

FIG. 14 is a diagram illustrating an example of making an attendance inconsistency report.

FIG. 15 is a diagram illustrating an example of making an attendance alert report.

FIG. 16 is a diagram illustrating a disposition example of a BLE receiving terminal.

### MODE FOR CARRYING OUT THE INVENTION

Hereinafter, embodiments will be described with reference to the drawings.

### Embodiment 1

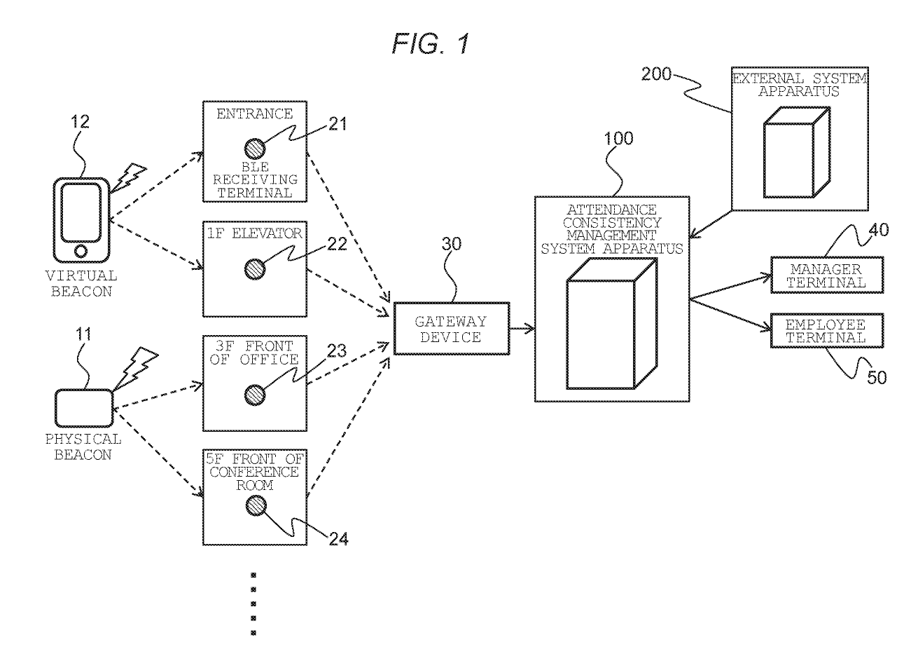

FIG. 1 illustrates a system configuration diagram of the attendance consistency management system proposed in the present embodiment, the outline of which will be described.

A plurality of Bluetooth (registered trademark) Low Energy (BLE) receiving terminals 21 to 24 conforming to BLE communication standards are distributedly installed on a ceiling of the inside of a building or an office, and the like.

An employee gets to work with carrying a beacon terminal 11 that emits a BLE radio wave or a terminal 12 that has an application mounted thereon, the application transmitting a beacon signal corresponding to the BLE.

Upon detecting a beacon signal in a coverage area, each BLE receiving terminals 21 to 24 receives a beacon ID (corresponding to an employee ID), and transmits, to a gateway device 30, a combination of the beacon ID and a BLE receiving terminal ID.

The gateway device 30 adds information on the received time to the combination information of the beacon ID and the BLE receiving terminal ID received from each BLE receiving terminal, and reports the information to an attendance consistency management system apparatus 100.

In addition to recording the reported information, the attendance consistency management system apparatus 100 generates history data of the received time for each beacon ID (employee ID), and calculates attendance time, departure time, and overtime hours of the corresponding employee from the history data of the received time, by reading out and referring to time table data of the corresponding employee ID from an external system apparatus 200 on which the existing attendance management system is mounted. Then, in a case where it is found that the attendance time, departure time, and overtime hours self-reported by the employee registered in the external system apparatus 200 is inconsistent with the attendance time, departure time, overtime hours measured and calculated by the attendance consistency management system, the attendance consistency management system apparatus 100 outputs a report to a manager terminal 40 and outputs a warning report to the employee terminal 50 who is about to reach the specified overtime hours.

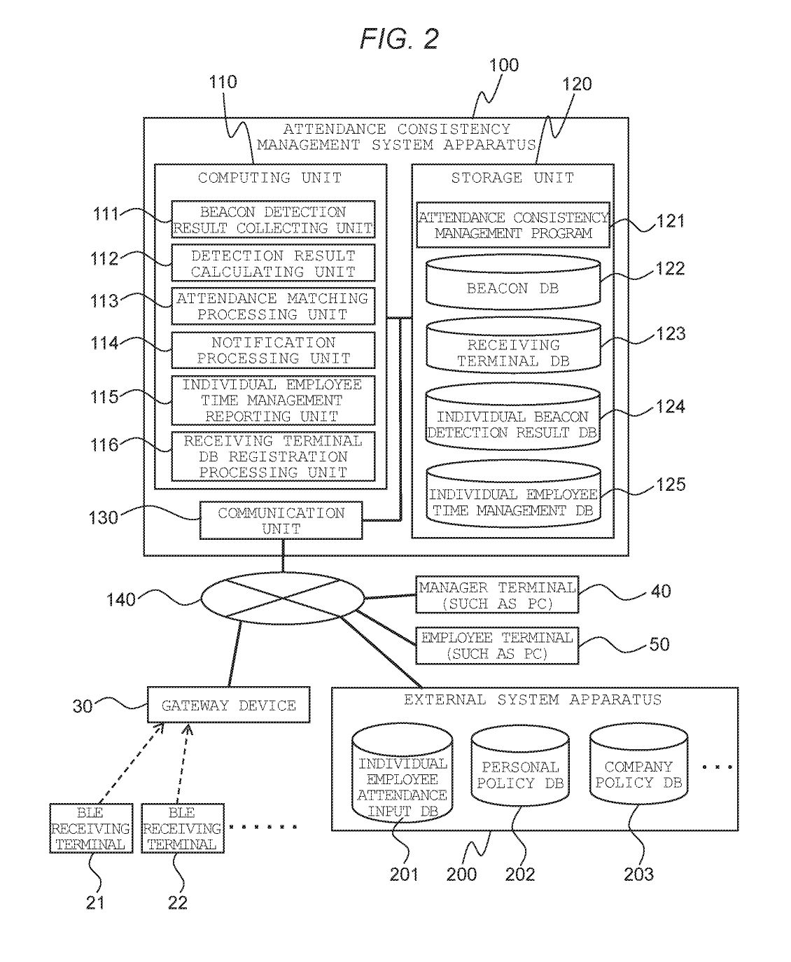

FIG. 2 illustrates the configuration of the attendance consistency management system apparatus 100.

The attendance consistency management system apparatus 100 may be configured on a computer (server), and the hardware configuration thereof has a computing unit 110 including a Central Processing Unit (CPU), a Random Access Memory (RAM), and the like, a storage unit 120 including a Read Only Memory (ROM), an Hard Disk Drive (HDD), an Solid State Drive (SSD) using a flash memory and the like, a communication unit 130 including a communication device, a network adapter and the like adapted for a network 140 such as the Internet, a wired or a wireless Local Area Network (LAN), or the like, and so on.

The communication unit 130 is connected to a manager terminal (a manager who is a manager for the employee of an employee terminal 50 and is a member of employees) 40, the employee terminal 50, the external system apparatus (on which the existing attendance management system is mounted) 200, a gateway device 30, and the like, through a network 140.

The storage unit 120 has an attendance consistency management program 121, a beacon DB 122, a receiving terminal DB 123, an individual beacon detection result DB 124, and an individual employee time management DB 125.

The computing unit 110 loads the attendance consistency management program 121 stored in the storage unit 120 into the RAM, then, when it is executed by the CPU, implements the following functional units. The computing unit 110 has a beacon detection result collecting unit 111, a detection result calculating unit 112, an attendance matching processing unit 113, a notification processing unit 114, an individual employee time management reporting unit 115, and a receiving terminal DB registration processing unit 116.

Incidentally, it is also conceivable that the attendance consistency management system apparatus 100 and the external system apparatus 200 are mounted on the same computer (server). Otherwise, it is also conceivable the attendance consistency management system apparatus 100 and the external system apparatus 200 is constructed on a cloud environment.

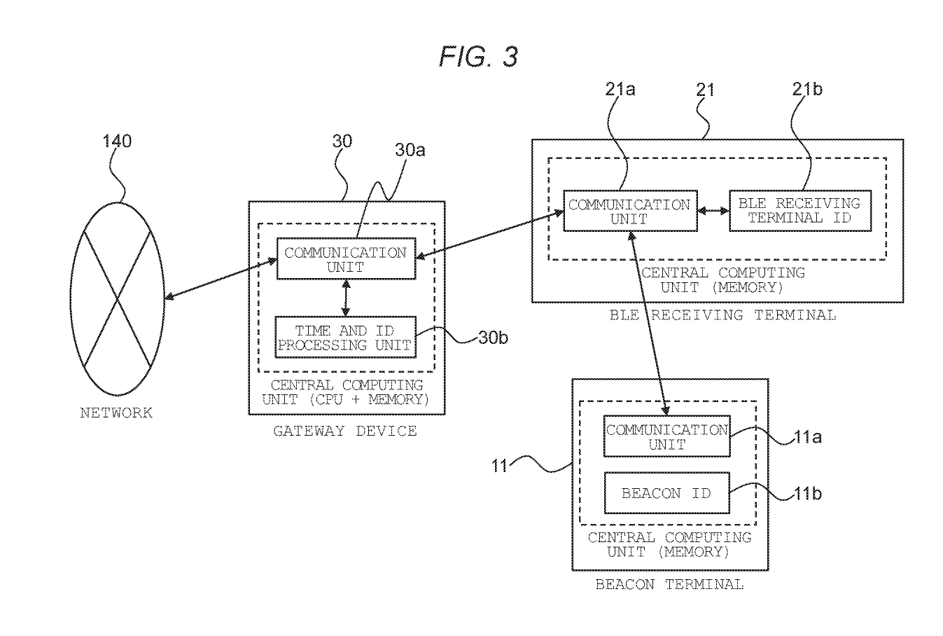

FIG. 3 illustrates a block diagram of the BLE receiving terminal 21, the beacon terminal 11, and the gateway device 30.

A communication unit 11a of the beacon terminal 11 periodically transmits a beacon signal conforming to the BLE communication standard, and transmits the beacon ID stored in a memory 11b to the BLE receiving terminal, in response to a request from the BLE receiving terminal 21.

Upon detecting the beacon signal conforming to the BLE communication standard in the coverage area at regular periods, a communication unit 21a of the BLE receiving terminal 21 requests the beacon ID and receives the beacon ID from the beacon terminal. The BLE receiving terminal ID stored in the memory 21b is added to the received beacon ID, which is subjected to, for example, protocol conversion processing to a wireless LAN, and then sent to the gateway device 30.

Upon receiving the combination data of the beacon ID and the BLE receiving terminal ID, a communication unit 30a of the gateway device 30 adds time information at that time in a time and ID processing unit 30b, as a time (received time) when the beacon terminal has been detected in the coverage area of the BLE receiving terminal. For example, if the network 140 is the Internet, the communication unit 30a performs conversion from the IPX/SPX protocol to the TCP/IP protocol on the combination data of the beacon ID, the BLE receiving terminal ID, and the received time, and transmits the converted data to the attendance consistency management system apparatus 100, through the network 140.

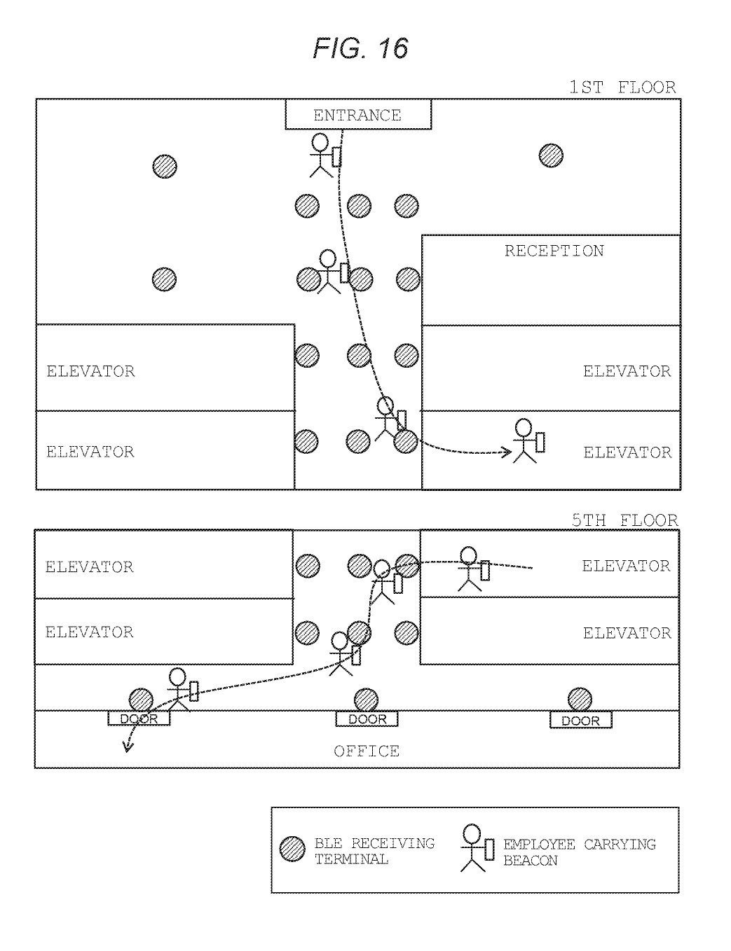

It is said that a coverage distance of the BLE receiving terminal is about 2.5 m to 50 m. However, as illustrated in FIG. 16, for example, coverage ranges of a plurality of BLE receiving terminals are disposed without omission such that the coverage ranges are somewhat narrowed and overlapped with each other in a passage area from 1st floor entrance of a certain company building to the front of an elevator and a ceiling of another passage area from the front of the elevator of a 5th floor with an office to the entrance of the office. For example, the BLE receiving terminals are disposed without omission into routes leading to all the entrances and exits, which are used when all employees of this company enter into or depart from the office.

In FIG. 16, when an employee carrying a beacon terminal gets to work, beacons are sequentially detected in the BLE receiving terminals along routes indicated by a broken line arrow, and the beacon ID information is recorded in the attendance consistency management system apparatus 100. When an employee departs from the company, the beacon ID information is similarly recorded.

Returning to FIG. 2, the description of the attendance consistency management system apparatus 100 is provided.

The beacon detection result collecting unit 111 receives, through the communication unit 130, the combination data of the beacon ID, the BLE receiving terminal ID, and the received time detected by each BLE receiving terminal transmitted from the gateway device 30, and records the combination data in the beacon DB 122.

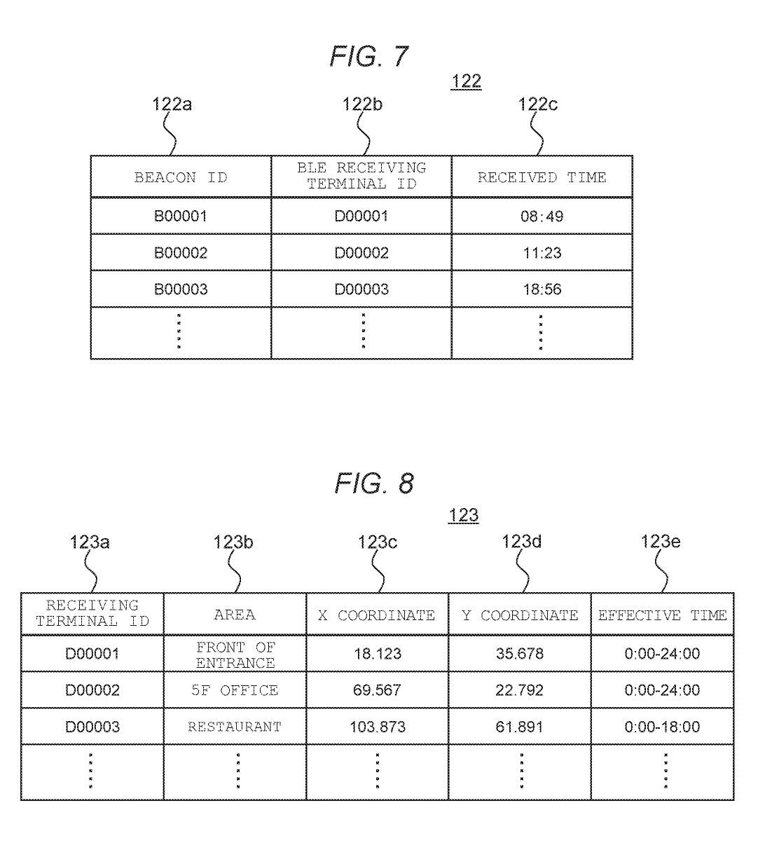

FIG. 7 illustrates a data table format in the beacon DB 122. Data items include a beacon ID 122a, a BLE receiving terminal ID 122b, and a receiving time 122c. Data records sent from the gateway device 30 are stored in time series.

FIG. 8 illustrates a data table format in the receiving terminal DB 123. When the BLE receiving terminal is installed on a ceiling of the inside of a building, an office, and the like, it is possible for the receiving terminal DB to designate a time band during the entrance of an employee as an effective time, in a case where a time band unused by the employee is provided depending on the installed location and data in which the installed location of each BLE receiving terminal is registered. The data items of the data table in the receiving terminal DB include a receiving terminal ID 123a, an area 123b, an X coordinate (a coordinate on the floor map of the building) 123c, a Y coordinate 123d, and an effective time 123e.

When installing the BLE receiving terminals or changing the disposition of the BLE receiving terminals, the receiving terminal DB registration processing unit 116 of the attendance consistency management system apparatus 100 is activated, and by a system administrator, the registration processing is performed on the receiving terminal DB from a system administrator terminal (not illustrated).

The detection result calculating unit 112 of the attendance consistency management system apparatus 100 writes the detection result into an individual beacon detection result DB 124 for recording the received time for each beacon ID in time series, if the received time of the beacon ID is within the received effective time of the BLE receiving terminal, by reading out data records sequentially and referring to the receiving terminal DB 123, by following that received time of beacon IDs is sequentially stored into the beacon DB 122.

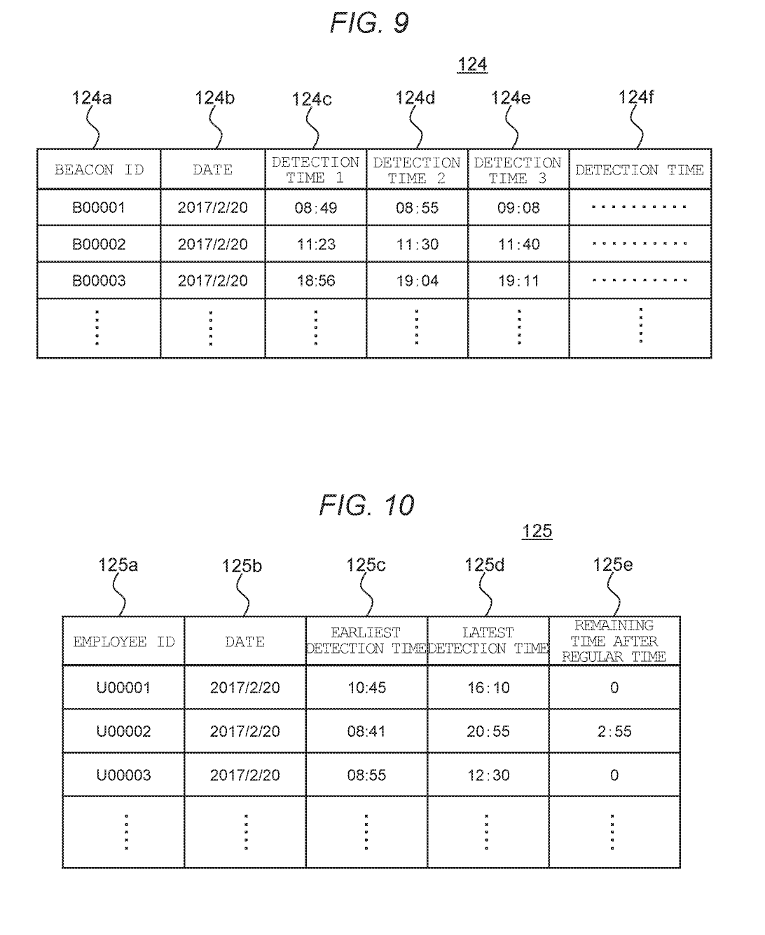

FIG. 9 illustrates the data table format in the individual beacon detection result DB 124. For example, the received time of the beacon ID 124a of “B00001” are sequentially recorded, from the earliest time, as the detection time 1 of “08:49”, the detection time 2 of “08:55”, and the detection time 3 of “09:08”, and subsequently the received time is continuously recorded into the following fields of the detection time 124f, and the like, all together. Sequential data of detection time is stored in respective rows of all the beacon IDs detected by all the BLE receiving terminals.

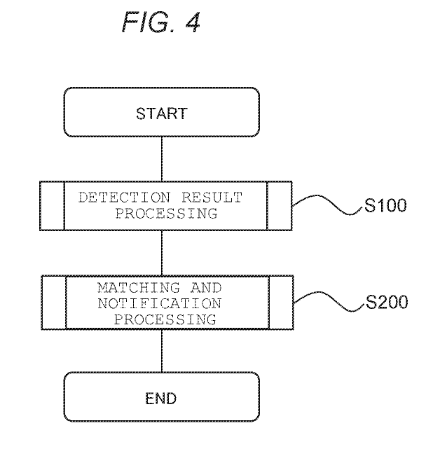

FIG. 4 illustrates an overall flowchart of the attendance consistency management system apparatus 100.

The detection result processing in step S100 is processing of collecting information on the beacon IDs detected by all the BLE receiving terminals installed in the ceiling of the inside of a building, an office, and the like, and recording the sequential data of the detection time for each beacon ID in the individual beacon detection result DB 124, which is continued to be daily executed.

The matching and notification processing in step S200 is activated at that time when the employee has entered attendance information on self-reporting in the existing attendance management system, and is executed to check a presence or absence of inconsistency by matching the self-reported attendance information with information obtained by the detection result processing in S100. In the presence of inconsistency, a notification is sent to the manager or the like.

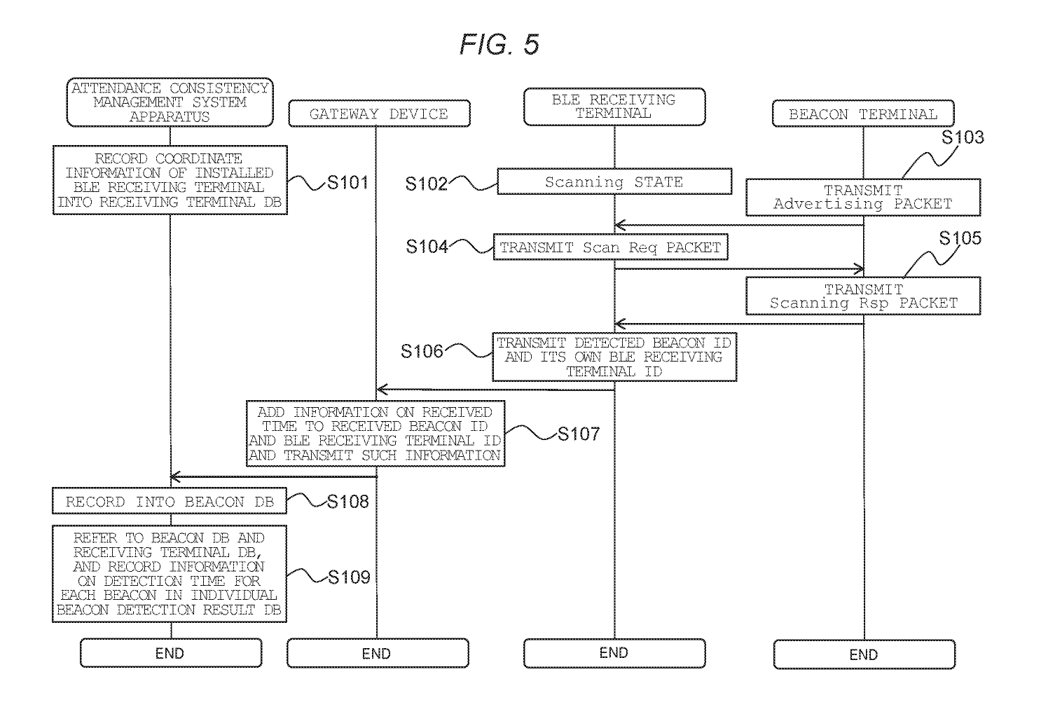

FIG. 5 illustrates a flowchart for detecting one beacon ID and executing the detection result processing in S100.

In step S101, the receiving terminal DB registration processing unit 116 is activated to record coordinate information of an installed BLE receiving terminal into the receiving terminal DB. Merely, this processing is executed when installing the BLE receiving terminal or changing the disposition thereof.

In step S102, the BLE receiving terminal enters into a Scanning state at, for example, 0.2 second intervals. (Merely, depending on the setting of a Scanning cycle and the number of BLE receiving terminals to be installed, there is a possibility that the detection data of the beacon ID become a huge amount of data. Therefore, the Scanning cycle may be tuned according to the amount of data and other conditions.)

In step S103, the beacon terminal periodically transmits an advertising packet.

In step S104, the BLE receiving terminal detects a beacon and transmits a Scan Req packet requesting a beacon ID.

In step S105, the beacon terminal transmits a Scan Rsp packet with the beacon ID in response to the request.

In step S106, the BLE receiving terminal transmits the detected beacon ID and its own BLE receiving terminal ID to the gateway device.

In step S107, the gateway device adds information on the received time to the received beacon ID and BLE receiving terminal ID, and transmits such information to the attendance consistency management system apparatus.

In step S108, the beacon detection result collecting unit 111 records the combination data of the beacon ID, the BLE receiving terminal ID, and the received time that have been received from the gateway device, into the beacon DB 122.

In step S109, by referring to the beacon DB and the receiving terminal DB, the detection result calculating unit 112 records information on the detection time for each beacon in the individual beacon detection result DB.

It will be described that the attendance matching processing unit 113 of the attendance consistency management system apparatus 100 reads out and refers to a personal policy DB 202, a company policy DB 203, and an individual employee attendance input DB 201, which are managed by the existing attendance management system mounted on the external system apparatus 200.

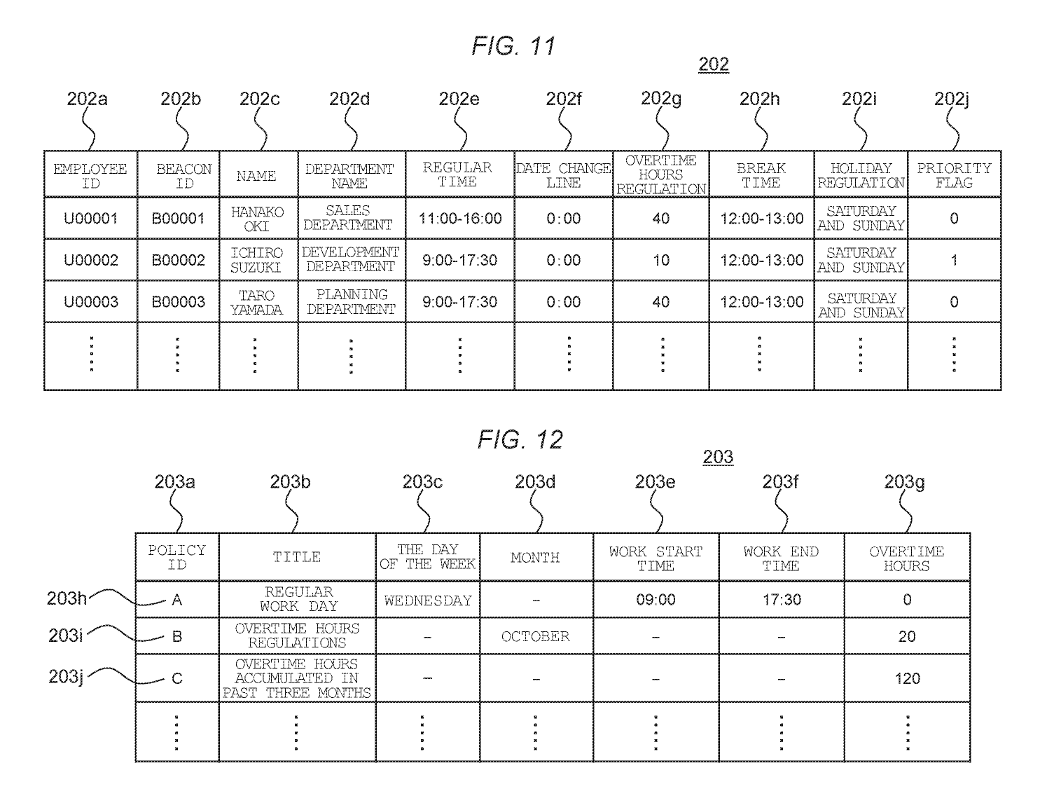

FIG. 11 illustrates the data table format in the personal policy DB 202. The personal policy DB stores work pattern information for each employee. The data items of the data table include an employee ID 202a, a beacon ID 202b, a name 202c, a department name 202d, a regular time 202e, a date change line 202f (designating where to count the date. A person who normally works has date change time of “0” o'clock, but another person who shiftly works has date change time different from “0” o'clock), overtime hours regulation 202g, break time 202h, holiday regulation 202i, and a priority flag 202j (the default of the priority flag is “0” (the company policy takes priority over the personal policy), but for a person having priority flag of “1”, the personal policy takes priority over the company policy).

FIG. 12 illustrates the data table format in the company policy DB 203. The company policy DB stores work pattern information that has been determined by the company as working regulations. For example, the company policy of a policy ID 203a of “A” (203h) specifies that regular work day is “Wednesday”, work start time is “09:00”, work end time is “17:30”, and overtime hours is “0”.

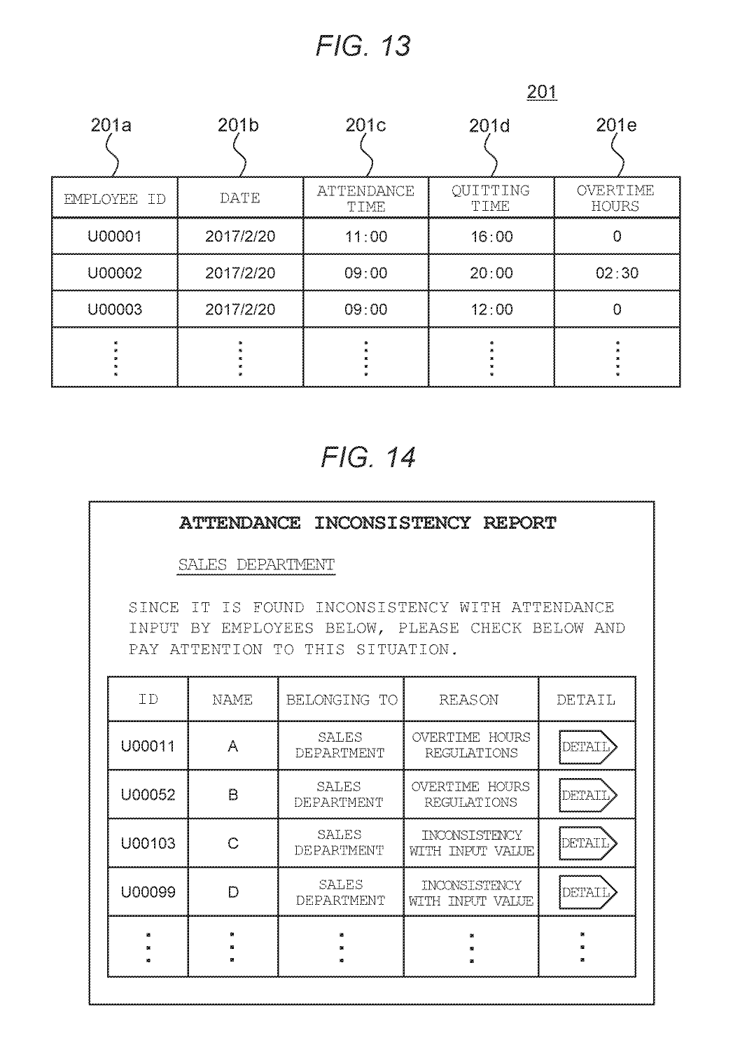

FIG. 13 illustrates the data table format in the individual employee attendance input DB 201. The individual employee attendance input DB stores information on attendance time, quitting time, and overtime hours for each date, which each employee has entered on self-reporting. The data items of the data table include an employee ID 201a, a date 201b, an attendance time 201c, a quitting time 201d, and overtime hours 201e.

The attendance matching processing unit 113 of the attendance consistency management system apparatus 100 performs attendance matching processing on data of date that has been entered into and stored in the individual employee attendance input DB 201. For example, in a case where attendance information on the date: 2017/2/20 has been self-reported by the employee (due date), the attendance matching processing on the date: 2017/2/20 is executed.

By reading out the data record of the corresponding date from the individual beacon detection result DB 124 and referring to the data of the employee ID 202a, the beacon ID 202b, and the regular time 202e of the personal policy DB 202, the attendance matching processing unit 113 performs recording on each data record of the individual employee time management DB 125 (see FIG. 10).

That is, the detection time 1 (124c), that is the earliest detection time from the sequential data of the detection time for each beacon ID arranged in each row of the individual beacon detection result DB 124 in FIG. 9, is recorded into the field of the earliest detection time 125c in the row of the corresponding employee ID of the individual employee time management DB 125 in FIG. 10. Further, the latest detection time recorded in the sequential data of the detection time for the same beacon ID is recorded into the field of the latest detection time 125d in the row of the corresponding employee ID of the individual employee time management DB 125.

Also, a period from the closing time of the work in the time table of the employee represented by the regular time 202e of the corresponding employee ID 202a, to the latest detection time 125d, is calculated as remaining time after regular time, and recorded into in the field of remaining time after regular time 125e. (Merely, overtime hours do not count 30 minutes before regular time, or 30 minutes after regular time that is buffer time.)

The time management information for each employee ID corresponding to the entire beacon IDs in the individual beacon detection result DB 124, is recorded into the individual employee time management DB 125.

Subsequently, the attendance matching processing unit 113 compares the generated individual employee time management DB 125 with the individual employee attendance input DB 201 self-reported by each employee.

In the comparison processing, among the data records, of which employee ID and date coincide, comparison is made between the earliest detection time 125c of the individual employee time management DB and the attendance time 201c of the individual employee attendance input DB, comparison is made between the latest detection time 125d of the individual employee time management DB and the quitting time 201d of the individual employee attendance input DB, and comparison is made between the remaining time after regular time 125e of the individual employee time management DB and the overtime hours 201e of the individual employee attendance input DB.

In each comparison processing, in a case where a result indicates a deviation greater than a predetermined allowable error, a presence of inconsistency is determined, or in a case where the result indicates a match within the allowable error, a presence of consistency is determined.

Also, the attendance matching processing unit 113 matches the generated individual employee time management DB 125, the personal policy DB 202, and the company policy DB 203 with one another, and determines a presence of inconsistency including cases where the working regulations have been violated, and are likely to be violated.

For example, Mr. Ichiro Suzuki having employee ID of “U00002” in the personal policy DB 202, is under working regulations, and the overtime hours regulations are set to 10 hours. However, in such a case, it is determined that the overtime hours accumulated in this month have already exceeded, or are likely to exceed.

Or, for example, the policy ID: A (203h) in the company policy DB 203 specifies that the regular work day is “Wednesday”. However, even though that day was “Wednesday”, there is a case where the remaining time has been recorded into the remaining time after regular time 125e in the individual employee time management DB.

Or, for example, the policy ID: B (203i) in the company policy DB 203 specifies that the overtime hours regulations are set to 20 hours in October. However, there is a case where it is determined that the overtime hours accumulated in this month have already exceeded, or are likely to exceed.

Or, for example, the policy ID: C (203j) in the company policy DB 203 specifies that the overtime hours accumulated in the past three months are set to 120 hours. However, there is a case where it is determined that the accumulated overtime hours up to this month have already exceeded or are likely to exceed.

In a case where the presence of inconsistency is determined in the attendance matching processing unit 113, the notification processing unit 114 of the attendance consistency management system apparatus 100 generates an attendance inconsistency report as illustrated in FIG. 14, and transmits it to a manager terminal of the corresponding employee.

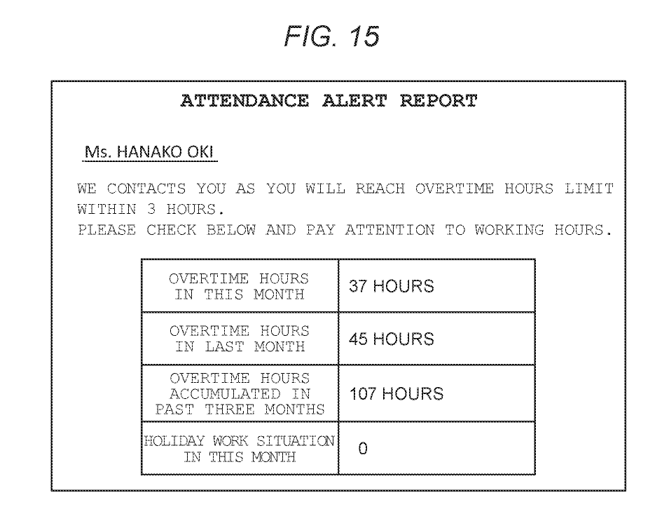

Also, the notification processing unit 114 generates an attendance alert report as illustrated in FIG. 15, and transmits it to the corresponding employee terminal.

In a case where a request is issued from the manager terminal or the employee terminal, the individual employee time management reporting unit 115 of the attendance consistency management system apparatus 100 generates a report to be submitted in a list of data records on the requested employee ID and date, from the information recorded in the individual employee time management DB 125, including information with inconsistency not to be determined, and submits this report to the manager terminal or employee terminal that has the request.

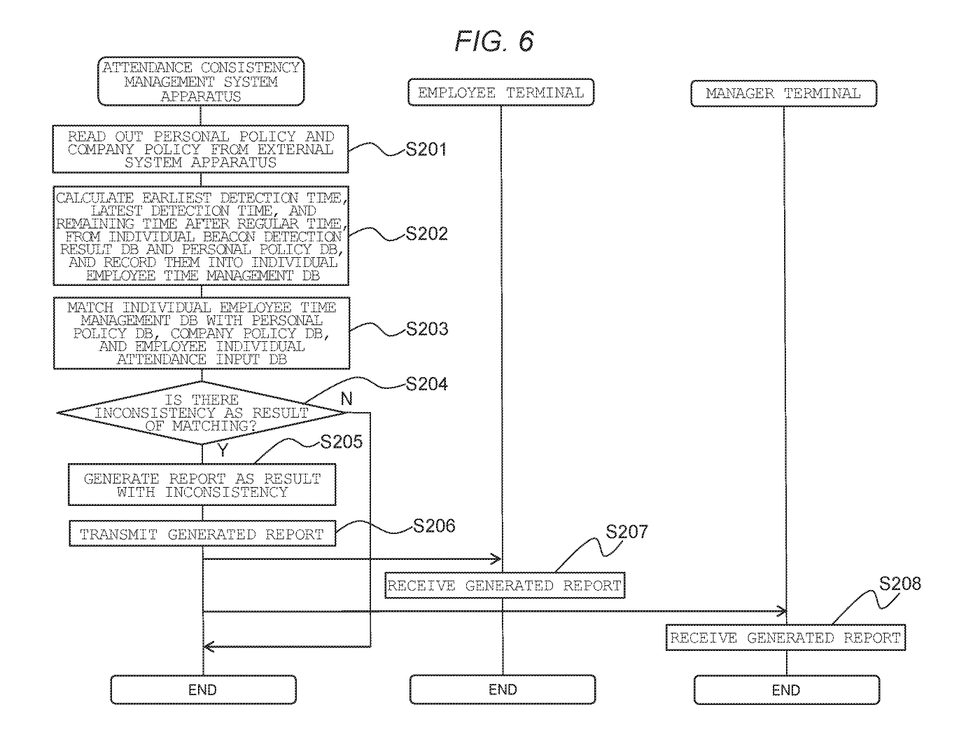

FIG. 6 illustrates a flowchart of the matching and notification processing (S200).

In step S201, the attendance matching processing unit 113 reads out the personal policy and company policy from the external system apparatus 200.

In step S202, the attendance matching processing unit 113 calculates the earliest detection time, the latest detection time, and the remaining time after regular time, from the individual beacon detection result DB 124 and the personal policy DB 202, and records them into the individual employee time management DB 125.

In step S203, the attendance matching processing unit 113 checks a presence of inconsistent items, by matching the individual employee time management DB with the personal policy DB, the company policy DB, and the employee individual attendance input DB.

In step S204, in a case where an item with inconsistency to be determined is present, the processing proceeds to S205, and in a case where no item with inconsistency to be determined is provided, the matching and notification processing is ended.

In step S205, the notification processing unit 114 is activated, and a report for submitting the result with inconsistency to be determined is generated.

In step S206, the generated report is transmitted to the employee terminal or the manager terminal.

In step S207, the employee terminal receives the generated report.

In step S208, the manager terminal receives the generated

An object of the attendance consistency management system of the present embodiment is to provide objective evidence in the audit. Therefore, it is considered that, in the attendance consistency management system apparatus 100, record data of the individual beacon detection result DB 124 is stored for at least one or more months, and the record data is sequentially discarded, after summary of monthly work days and holidays is completed.

Also, since record data in the individual employee time management DB 125 is the final official evidence, the record data is stored for at least about one year.

### REFERENCE SIGNS LIST

11 Beacon terminal
11a Communication unit
11b Beacon ID
12 Terminal that has an application mounted thereon, the application transmitting a beacon signal corresponding to the BLE
21 to 24 BLE receiving terminal
21a Communication unit
21b BLE receiving terminal ID
30 Gateway device
30a Communication unit
30b Time and ID processing unit
40 Manager terminal
50 Employee terminal
100 Attendance consistency management system apparatus
110 Computing unit
111 Beacon detection result collecting unit
112 Detection result calculating unit
113 Attendance matching processing unit
114 Notification processing unit
115 Individual employee time management reporting unit
116 Receiving terminal DB registration processing unit
120 Storage unit
121 Attendance consistency management program
122 Beacon DB
123 Receiving terminal DB
124 Individual beacon detection result DB
125 Individual employee time management DB
130 Communication unit
140 Network
200 External system apparatus
201 Individual employee attendance input DB
202 Personal policy DB
203 Company policy DB

1. An attendance consistency management system, comprising:
a beacon detection result collecting unit that is distributedly installed along an entrance path into and exit path from the inside of a building or an office, collects beacon ID information from a plurality of receiving terminals detecting a beacon of a transmission terminal carried by an employee, and records the beacon ID information together with detection time information;
a detection result calculating unit that generates a sequential data table of detection time for each beacon ID based on the recorded beacon ID information and detection time information; and
an attendance matching processing unit that calculates the earliest detection time, the latest detection time, and remaining time after regular time of the employee, based on the sequential data table of detection time for each beacon ID and regular time information of an employee specified by the beacon ID, and determines consistency with attendance information entered by the employee on self-reporting, working regulations of individual employees, and working regulations of a company.

2. The attendance consistency management system according to claim 1, further comprising:
a notification processing unit,
wherein, in a case where an item with inconsistency to be determined is present as a determination result of the attendance matching processing unit, the notification processing unit generates a report for submitting a result with inconsistency to be determined, and transmits the generated report to a terminal during the regular work of the employee, or a manager terminal.

3. The attendance consistency management system according to claim 1,
wherein a gateway device intervenes on a path through which the beacon detection result collecting unit collects beacon ID information from the plurality of receiving terminals, and the gateway device transmits, to the beacon detection result collecting unit, information obtained by adding detection time information when receiving the beacon ID information detected from each receiving terminal.

4. The attendance consistency management system according to claim 1,
wherein the detection result calculating unit records sequential data of all the corresponding detection times into a data table, by using detection time detected earliest on that day as the first data, in order of earlier detection time, for each beacon ID based on the recorded beacon ID information and detection time information.

5. The attendance consistency management system according to claim 1,
wherein the attendance matching processing unit records detection time detected earliest from the sequential data table of detection time for each beacon ID, as the earliest detection time of the employee specified by the beacon ID, and determines consistency with an attendance time of the employee in an individual employee attendance input DB.

6. The attendance consistency management system according to claim 1,
wherein the attendance matching processing unit records detection time detected latest from the sequential data table of detection time for each beacon ID, as the latest detection time of the employee specified by the beacon ID, and determines consistency with a quitting time of the employee in an individual employee attendance input DB.

7. The attendance consistency management system according to claim 1,
wherein in a case where a delay period, from closing time of the work of the regular time of the employee, to the latest detection time as detection time detected latest, is calculated based on the sequential data table of detection time for each beacon ID and regular time information of an employee specified by the beacon ID, the attendance matching processing unit records the delay period as the remaining time after regular time of the employee, and determines consistency with overtime hours of the employee in an individual employee attendance input DB.

8. An attendance consistency management method of collecting information on attendance time and quitting time of an employee and determining consistency with attendance information, when executed by a computer, the method comprising:
a step of collecting beacon ID information from a plurality of receiving terminals detecting a beacon of a transmission terminal carried by an employee, and recording the beacon ID information together with detection time information, through distributed installation along an entrance path into and exit path from the inside of a building or an office;
a step of generating a sequential data table of detection time for each beacon ID based on the recorded beacon ID information and detection time information;
a step of calculating the earliest detection time, the latest detection time, and remaining time after regular time of the employee based on the sequential data table of detection time for each beacon ID and regular time information of an employee specified by the beacon ID, and determining consistency with attendance information entered by the employee on self-reporting, working regulations of individual employees, and working regulations of a company;
a step of generating a report for submitting a result with inconsistency to be determined, in a case where there is present an item with inconsistency to be determined in the step of determining consistency, and transmitting the generated report to an employee terminal or a manager terminal.

9. The attendance consistency management method according to claim 8,
wherein the step of generating a sequential data table of detection time for each beacon ID is a step of recording sequential data of all the corresponding detection times into a data table, by using detection time detected earliest on that day as the first data, in order of earlier detection time, for each beacon ID based on the recorded beacon ID information and detection time information.

10. The attendance consistency management method according to claim 8,
wherein the step of determining consistency is a step of recording detection time detected latest from the sequential data table of detection time for each beacon ID, as the latest detection time of the employee specified by the beacon ID, and determining consistency with a quitting time of the employee in an individual employee attendance input DB.
